(19) United States
(12) Patent Application Publication
(10) Pub. No.: US 2002/0116928 A1
(43) Pub. Date: Aug. 29, 2002

(54) Solar power generation system provided with sun-chasing mechanism

(76) Inventors: Tatsuo Fujisaki, Nara (JP); Satoru Shiomi, Shizuoka (JP); Makoto Sasaoka, Kyoto (JP); Hidehisa Makita, Kyoto (JP); Shigenori Itoyama, Nara (JP)

Correspondence Address: FITZPATRICK CELLA HARPER & SCINTO, 30 ROCKEFELLER PLAZA, NEW YORK, NY, 10112, US

(21) Appl. No.: 10/025,559

(22) Filed: Dec. 26, 2001

(30) Foreign Application Priority Data
Dec. 20, 2000 (JP) 2000-395150
Dec. 26, 2001 (JP) 2001-373782

(51) Int. Cl. F03G 6/00; F03G 7/00; B60L 8/00; B60K 16/00

(52) U.S. Cl. 60/641.8; 60/641.15

(57) ABSTRACT

A solar power generation system comprising a solar module and a sun-chasing mechanism for driving and controlling said solar module based on said output from said solar module, said sun-chasing mechanism having a drive means, a drive-controlling means, and a clock means, wherein said sun-chasing mechanism behaves to perform sun-chasing of said solar module such that the solar module is driven by a first sun-chasing mode when sun shines; when the output value from the solar module becomes to be below a fist prescribed value, the first sun-chasing mode is switched to a second sun-chasing mode based on said output value from the solar module and an output value from said clock means, and the solar module is driven by said second sun-chasing mode; and when the output from the solar module becomes to be above a second prescribed value, the second sun-chasing mode is switched to the fist sun-chasing mode and the solar module is driven by the fist sun-chasing mode; and wherein the sun-chasing mechanism behaves such that when the output value from the solar module becomes to be below a third prescribed value at a time within a range of a first prescribed time from a sunset time computed from the clock means, the sun-chasing of the solar module is terminated.

### BACKGROUND OF THE INVENTION

1. Field of the Invention

The present invention relates to a solar power generation system. More particularly, the present invention relates to a solar power generation system provided with a sun-chasing mechanism. The term “solar module” in the present invention is meant an assembly of a photoelectric conversion element (including a photovoltaic element or solar cell) and other necessary components including associated wiring, which is used for converting incident sunlight into electric energy.

2. Related Background Art

In recent years, as an energy source which is safe and applies no load to the environment, public attention has been focused on a solar power generation system in which a solar module is used and which generates electric power by irradiating sunlight to the solar module without causing pollution. And it has been recognized that such a solar power generation system is more beneficial also from the viewpoint of economy in comparison with the conventional type power generation system such as thermal power generation system. In view of this, various studies have been performing in order to develop solar modules having a high photoelectric conversion efficiency and which can be provided at reasonable cost. Under these circumstances, sun-chasing type solar modules have received public attention.

Incidentally, in the ordinary solar power generation system, the solar module is fixed at a prescribed position. However, as a matter of course, the relation between the sun and the earth is momently changing. Thus, it can be said that the duration when the relative angle between the fixed solar module and the sun becomes optimum is only in a moment and in cases besides this, the solar module receives solar energy at inadequate angles. This situation is similar not only for the direction (the so-called hour angle) of the sun when viewed from the solar module side but also for the seasonal changes of the passage route of the sun (changes in the latitude). Further, the reflectance at the surface of the solar module is increased as the incident angle of the sun light is departed from the normal line of the solar module. Thus, when the light-receiving angle of the solar module is inadequate, light loss is occurred. Here, it is generally recognized that the light loss will be 20 to 30% of the solar energy received by the solar module. In order to eliminate such inappropriateness of the light receiving angle, it is necessary to make the solar module so that it can be always maintained at an optimum angle against the sun. In view of this, there has proposed a so-called sun-chasing type solar power generation system designed so that it can chase the sun. Only by making the solar module used in such solar power generation system such that it can chase the sun, it is expected that the magnitude of the foregoing light loss is diminished to a certain extent and the yearly generated energy will be increased by 25 to 45%. Besides the above proposal, there has proposed a solar power generation system in which an optical-concentration type solar module is used, aiming at diminishing the power generation cost. The use of the optical-concentration type solar module provides advantages such that the number of solar modules which are most expensive of the components constituting the solar power generation system can be diminished and as a result, the production cost of the solar power generation system can be markedly reduced.

Incidentally, in a solar power generation system in which a solar module is used, it is known that when the intensity of incident light which is impinged in the solar module is increased, a large voltage is generated, where the rate of the output power to the incident light energy, namely, the photoelectric conversion efficiency is improved, and there can be achieved a relatively large power output. In this case, when said solar module comprises a plurality of solar modules which are arranged on a common area while being electrically connected with each other, the power output can be more increased. Further, when said solar module comprises a plurality of optical-concentration type solar modules which are arranged on a common area while being electrically connected with each other, the power output can be markedly increased. Even in this case, in order to always achieve a sufficient power output by sufficiently increasing the photoelectric conversion efficiency, it is necessary that an optical focusing system with a high magnification is adopted and a sun-chasing mechanism is provided therein.

As the sun-chasing method, there is known a method wherein a clocking means is provided in the driving means for driving the solar module, the position of the sun is computed on the basis of information concerning the date and time obtained from the clocking means, and the solar module is driven so as to oppose the position of the passage route of the sun by the driving means. However, this sun-chasing method has disadvantages such that an error in the installation angle of the system upon the installation thereof and an error in the structure of the solar module upon the production thereof invite adverse effects and besides, the sun-chasing performance gradually becomes inaccurate as timing error generally present in the clocking means is accumulated. In order to solve such problems Japanese Unexamined Patent Publication No. 19857/1995, Japanese Patent Publication No. 56671/1993, and Japanese Patent Publication No. 31547/1995 propose systems in which using a sun-direction detecting sensor (or solar module) for chasing the sun, the solar module is driven in a direction where the output of the detecting sensor is maximized. However, such system has drawbacks such that the cost is increased because the detecting sensor is additionally provided and the sun-chasing performance becomes inaccurate due to an error in the installation of the detecting sensor or a change in the direction of the detecting sensor which is caused due to gradual deformation with time elapse of the installation portion of the detecting sensor because of wind pressure and the like. Besides, there is also a drawback such that in order to recognize the direction where the output of the detecting sensor is the maximum, there will be sometimes occurred necessity of greatly changing the positional direction of the solar module or the detecting sensor, where extra driving energy is consumed or the operation efficiency of the power generation function is deteriorated.

Besides, for the behavior of the solar module upon the sunset time, there has proposed a method wherein the solar module is returned to the initial position, as disclosed in Japanese Unexamined Patent Publication No. 149059/1999. There also has proposed a method wherein upon the sunset time, the solar module is returned to the position for waiting for the sunrise in the following day by means of a time relay, as disclosed in Japanese Patent Publication No. 56671/1993. However, these methods are merely focused on the function of chasing the sun but have no idea to improve the balance of the receipts and disbursements while taking the energy gain by the sun-chasing and the energy loss in the sun-chasing into consideration.

### SUMMARY OF THE INVENTION

In view of the technical situation relating to the sun-chasing in the conventional solar power generation system, the present invention is aimed at solving the foregoing problems in the prior art.

Particularly, another object of the present invention is to provide a solar power generation system structured so that sun-chasing of the solar module can be performed at a high precision and the sun-chasing can be optimally performed without wastefulness.

A further object of the present invention is to provide a solar power generation system provided with an inexpensive sun-chasing mechanism for the solar module installed therein, which is capable of accurately chasing the direction of the sun, while preventing the sun-chasing performance from being deteriorated due to an error in the installation of the solar module, and without necessity of additionally using a sun-direction detecting sensor and without necessity of paying consideration on the installation accuracy of the detecting sensor and also on changes with time lapse in the installation portion of the detecting sensor.

A typical embodiment of the solar power generation system of the present invention comprises a solar module in which incident light is subjected to photoelectric conversion to afford an output and a sun-chasing mechanism for driving and controlling said solar module on the basis of an output from said solar module, said sun-chasing mechanism having a drive means for changing the direction of said solar module, a drive-controlling means for controlling said drive means, an output detection means for detecting said output from said solar module, and a clock means for transmitting information relating to date and time to said drive-controlling means, wherein said sun-chasing mechanism behaves to perform sun-chasing of the solar module such that the solar module is driven by a first sun-chasing mode when sun shines; when the output value from the solar module becomes to be below a fist prescribed value, the first sun-chasing mode is switched to a second sun-chasing mode on the basis of said output value from the solar module and an output value from said clock means, and the solar module is driven by said second sun-chasing mode; and when the output from the solar module becomes to be above a second prescribed value, the second sun-chasing mode is switched to the fist sun-chasing mode and the solar module is driven by the fist sun-chasing mode; and wherein the sun-chasing mechanism behaves such that when the output value from the solar module becomes to be below a third prescribed value at a time within a first prescribed time range from a sunset time computed from the clock means, the sun-chasing of the solar module is terminated.

It is possible that instead of the output from the solar module, a solar irradiation of sunlight is used.

The solar power generation system in this case is of the contents as will be described below.

That is, the solar power generation system in which the solar irradiation is utilized, comprises a solar module in which incident light is subjected to photoelectric conversion to afford an output and a sun-chasing mechanism for driving and controlling said solar module on the basis of an output from said solar module, said sun-chasing mechanism having a drive means for changing the direction of said solar module, a drive-controlling means for controlling said drive means, a output detection means for detecting said output from said solar module, and a clock means for transmitting information relating to date and time to said drive-controlling means, wherein said sun-chasing mechanism behaves to perform sun-chasing of the solar module such that the solar module is driven by a first sun-chasing mode when sun shines; when a solar irradiation value of the sunlight becomes to be below a fist prescribed value, the first sun-chasing mode is switched to a second sun-chasing mode on the basis of the solar irradiation value and an output value from said clock means, and the solar module is driven by said second sun-chasing mode; and when the solar irradiation value becomes to be above a second prescribed value, the second sun-chasing mode is switched to the fist sun-chasing mode and the solar module is driven by the fist sun-chasing mode; and wherein the sun-chasing mechanism behaves such that when the solar irradiation value becomes to be below a third prescribed value at a time within a first prescribed time range from a sunset time computed from the clock means, the sun-chasing of the solar module is terminated.

The solar power generation system having such specific sun-chasing mechanism as above described in the present invention has such significant advantages as will be described below.

When the solar irradiation (or the solar irradiance) of the sunlight is large to an extent in that the solar module can sufficiently perform sun-chasing, the solar module is driven by the first sun-chasing mode based on the output from the solar module. When the solar irradiation is reduced to an extent in that the operation of the solar module to receive the sunlight by the first sun-chasing mode is insufficient, the first sun-chasing mode is switched to the second sun-chasing mode based on the output from the clock means and the solar module is driven by the second sun-chasing mode. Thereafter, when the solar irradiation is recovered to a sufficient extent suitable for the solar module to be driven by the first sun-chasing mode, the second sun-chasing mode is switched to the first sun-chasing mode and the solar module is driven by the first sun-chasing mode. By doing in this way, the solar module in the solar power generation system can be always driven by an adequate sun-chasing mode and because of this, the power generation quantity of the solar power generation system can be always maximized.

### BRIEF DESCRIPTION OF THE DRAWINGS

FIG. 1 is a schematic diagram illustrating the constitution of an example of a solar power generation system of the present invention.

FIGS. 2(a) to 2(c) are schematic views for explaining an example of a method for detecting a direction of the sun in the solar power generation system shown in FIG. 1.

FIGS. 3(a) to 3(c) are schematic Views for explaining another example of a method f or detecting a direction at the sun in the solar power generation system shown in FIG. 1.

FIGS. 4(a) to 4(c) are schematic views for explaining a further example of a method f or detecting a direction of the sun in the solar power generation system shown in FIG. 1.

FIG. 5 is a schematic flow chart showing motions realized by a sun-chasing mechanism based on an output from a solar module [a photoelectric conversion portion (102)] in the solar power generation system shown in FIG. 1.

FIG. 6 is a schematic flow chart showing motions realized by a sun-chasing mechanism based on a solar irradiation of sunlight instead of the output from the solar module in the solar power generation system shown in FIG. 1.

### DESCRIPTION OF THE INVENTION AND PREFERRED EMBODIMENTS

As previously described, the present invention typically provides a solar power generation system comprising a solar module in which incident light is subjected to photoelectric conversion to generate and output a power and a sun-chasing mechanism for driving and controlling said solar module on the basis of an output from said solar module, said sun-chasing mechanism having a drive means for changing the direction of said solar module, a drive-controlling means for controlling said drive means, an output detection means for detecting said output from said solar module, and a clock means for transmitting information relating to date and time to said drive-controlling means, wherein said sun-chasing mechanism behaves to perform sun-chasing of the solar module such that the solar module is driven by a first sun-chasing mode when sun shines; the output value from the solar module by means of said output detection means becomes to be below a fist prescribed value, the first sun-chasing mode is switched to a second sun-chasing mode on the basis of said output value from the solar module and an output value from said clock means, and the solar module is driven by said second sun-chasing mode; and when the output from the solar module by means of the output detection means becomes to be above a second prescribed value, the second sun-chasing mode is switched to the fist sun-chasing mode and the solar module is driven by the fist sun-chasing mode; and wherein the sun-chasing mechanism behaves such that when the output value from the solar module by means of the output detection means becomes to be below a third prescribed value at a time within a first prescribed time range from a sunset time computed from the clock means, the sun-chasing of the solar module is terminated.

The sun-chasing mechanism in the solar power generation system behaves specifically, for instance, as will be described below.

That is, when the sun shines, the solar module in the solar power generation system is driven by the first sun-chasing mode. When the output value from the solar module becomes to be below the fist prescribed value, the first sun-chasing mode is switched to the second sun-chasing mode on the basis of said output value from the solar module and the output value from the clock means, and the solar module is driven by the second sun-chasing mode. When the output value from the solar module in the drive by the second sun-chasing mode becomes to be above the second prescribed value, the second sun-chasing mode is switched to the fist sun-chasing mode and the solar module is driven by the fist sun-chasing mode. In the case where the time when the output value from the solar module becomes to be below the third prescribed value is within the first prescribed time range from the sunset time computed from the clock means, the sun-chasing operation of the solar module is terminated. In this case, it is possible that the solar module is moved to the position of the sun after elapse of the second prescribed time since the sunrise time in the following day and it is stopped and kept in a stand-by condition. During the solar module being kept in the stand-by condition, when a time after the second prescribed time since the sunrise time reaches or when the output value becomes to be above a fourth prescribed value, the sun-chasing operation of the solar module is restarted. Incidentally, as previously described, it is possible to control the solar power generation system based on a solar irradiation of the sunlight instead of the output from the solar module.

In the solar power generation system of the present invention, when the solar irradiation (or the solar irradiance) of the sunlight is large to an extent in that the sun-chasing of the solar module can be sufficiently performed, the solar module is driven by the first sun-chasing mode based on the output from the solar module. When the solar irradiation is reduced to an extent in that the operation of the solar module to receive the sunlight by the first sun-chasing mode is insufficient, the first sun-chasing mode it switched to the second sun-chasing mode based on the output from the clock means and the solar module is driven by the second sun-chasing mode. Thereafter, when the solar irradiation is recovered to a sufficient extent suitable for the solar module to be driven by the first sun-chasing mode, the second sun-chasing mode is switched to the first sun-chasing mode and the solar module is driven by the first sun-chasing mode. By doing in this way, the solar module in the solar power generation system can be always driven by an adequate sun-chasing mode and because of this, the power generation quantity of the solar power generation system can be always maximized.

Now, the solar irradiation itself of the sunlight to the solar power generation system installed outdoors is not constant against the hour angle throughout the day but it takes a maximum value at the time of culmination and it is nearly equal to zero in the early morning and in the evening. This is a phenomenon which is inevitably occurred due to a cause that the sir mass becomes extremely large when the altitude of the sun is small. Accordingly, when the sun-chasing of the solar power generation system is continued from the theoretical sunrise to the theoretical sunset, there will be a time zone where a loss of the energy required for performing the sun-chasing is occurred. Based on this recognition, by commencing the sun-chasing of the solar power generation system when the solar irradiation of the sunlight becomes to be above a given value after the sunrise and terminating the sun-chasing when the solar irradiation of the sunlight becomes to be below a given value, the output of the solar power generation system can be maximized. However, not only a reduction in the solar irradiation of the sunlight due to a change in the weather but also a reduction in the solar irradiation of the sunlight at the time of the sunset are difficult to recognize only by observing the output of the solar power generation system.

In the present invention, as described in the above, a reduction in the solar irradiation of the sunlight at the time of the sunset is detected based on the information from the clock means and the sun-chasing operation of the solar power generation system is terminated. After the termination of the sun-chasing operation, the solar module in the solar power generation system is moved until an estimate position of the sun at a time of [(the sunrise time in the morning of the following day)+(the second prescribed time)], where it is possible that the movement of the solar module is terminated and the solar module is kept in a stand-by condition. Then, at the time when the sun-chasing drive of the solar module is restarted after the sunrise in the morning of the following day, there is adopted (a) a manner in that the sun-chasing of the solar module is commenced when the time [(the sunrise time in the morning of the following day)+(the second prescribed time)] is reached or (b) a manner in that the sun-chasing of the solar module is commenced when the output of the solar power generation system becomes to be above fourth prescribed value (specifically, for instance, when it is possible to perform the sun-chasing of the solar module to achieve a desirable output before the time [(the sunrise time in the morning of the following day)+(the second prescribed time)] is reached). Particularly, in the case of the method (b) where the weather is fine, that is, the sun shines, the solar module in the solar power generation system is driven by the first sun-chasing mode under a condition which makes it possible to obtain an output with gains by performing the sun-chasing of the solar module. In the case of the method (a) where the weather is not fine after the time [(the sunrise time in the morning of the following day)+(the second prescribed time)], the solar module is driven by the second sun-chasing mode. By doing in this way, it is possible to find out a condition suitable for switching to the first sun-chasing mode when the weather is improved. In accordance with the condition, the second sun-chasing mode is switched to the first sun-chasing mode and the solar module is driven by the first sun-chasing mode.

The first prescribed time and the second prescribed time can be determined as will be described below.

The First Prescribed Time

Using sunlight irradiation data in which a case of an average sunlight irradiation condition is presumed, in a time range which is continued in a reverse direction from the sunset time, a value of the energy obtained by the sun-chasing which is accumulated in the reverse direction is computed and a value of the energy consumed for the sun-chasing which is accumulated in the reverse direction is computed. A time interval required for the former to overtake the latter is computed. The result is made to be the first prescribed time.

The Second Prescribed Value

Using sunlight irradiation data in which a case of an average sunlight irradiation condition is presumed, in a time range which is continued from the sunrise time, a value of the energy obtained by the sun-chasing which is accumulated in the forward direction is computed and a value of the energy consumed for the sun-chasing which is accumulated in the forward direction is computed. A time interval required for the former to overtake the latter is computed. The result is made to be the second prescribed time.

As previously described, the solar power generation system of the present invention comprises a solar module in which incident light is subjected to photoelectric conversion to generate and output a power and a sun-chasing mechanism for driving and controlling said solar module on the basis of an output from said solar module, said sun-chasing mechanism having at least a drive means for changing the direction of said solar module, a drive-controlling means for controlling said drive means, and an output detection means for detecting said output from said solar module. Specifically, the solar module is mechanically connected to the drive means. At this time, the drive means may be equipped with a support member for supplementarily support the solar module or a support mechanism for supporting the solar module in a state that the substrate can be freely moved or rotated as required. Further, the drive means may be equipped with a transmission mechanism for transmitting a driving force to the drive means.

The drive-controlling means is connected the drive means. The output detection means, is arranged on an output wiring of the, solar module for outputting an electricity to the outside such that the output detection means is electrically connected with the wiring. It is preferred that the output detection means is connected with the electricity output wiring in series connection. This is not limitative. The arrangement of the output detection means on the electricity output wiring may be performed by other appropriate arrangement method.

The output from the output detection means is transmitted into the drive-controlling means connected to the drive means.

The drive-controlling means is programmed to realize, for instance, such functions as will be described below.

(1) A driving signal for driving the drive means in one direction is transmitted to the drive means while overlapping a periodical slight movement signal on said driving signal;

(2) A direction where the output is increased is judged by a manner of comparing a fluctuation component of an output signal detected by the output detection means with aforesaid slight movement signal generated by the drive-controlling means and detecting a phase difference between the slight movement signal and the fluctuation signal; and

(3) A driving signal for driving the drive means in the above-judged direction is transmitted to the drive means.

The drive-controlling means is designed to exhibit the prescribed functions based on the output signals obtained in this way.

In the above, for conveniences sake, description has been made such that independent means is provided for every function. However, it is possible that single means is made to perform a plurality of functions.

In the following, description will be made of each of the components constituting the solar power generation system of the present invention.

### Solar Module

The solar module used in the solar power generation system of the present invention comprises a member having a photoelectric conversion element for converting sunlight energy into electric energy. Specifically, the solar module typically comprises a member structured to have one or more photoelectric conversion elements capable of converting sunlight energy into electric energy. The solar module functions to convert incident sunlight into electric energy (a power) by way of photoelectric conversion and output the electric energy to the outside. As specific examples of such photoelectric conversion element, there can be mentioned photoelectric conversion elements comprising adequate semiconductor materials. Such semiconductor material can include crystalline semiconductor materials, amorphous semiconductor materials, and compound semiconductor materials such as GaAs, CdTe, CuInSe₂ and the like. These are not limitative. Any other photoelectric conversion elements can be optionally used as long as they exhibit the foregoing function.

In the case where an optical-concentration type solar module as the solar module used in the present inventions, only by means of a portion which converts sunlight energy into electric energy, namely a photoelectric conversion portion (hereinafter, this will be occasionally called a solar cell in a narrow sense), a power generation operation cannot be sufficiently performed in general. It is necessitated to use an optical focusing system for converging light. A combination of said photoelectric conversion portion and said optical focusing system will be hereinafter called a solar module.

As the optical focusing system, any known optical focusing systems con be optionally used. As specific examples of such optical focusing system there can be mentioned a refracting optical system in which a simple lens or a thin type Fresnel lens used, a refracting optical system in which a reflecting mirror comprising a parabolic mirror is used, and a composite optical system comprising these refracting systems.

### Drive Means

As the drive means for changing the direction of the solar module (that is, the direction of the light receiving face (or the front face) of the solar module, any driving apparatus may be selectively used as long as they are able to position the solar module such that the light receiving face thereof faces toward the sun. As specific examples of such driving apparatus usable as the drive means, there can be mentioned DC motor, AC motor, stepping motor, pulse motor, synchronous motor, induction motor, gasoline engine, diesel engines and combinations of any of these and reduction year. These are not limitative. Other apparatus which function as above described are also usable. To make the solar module to chase the sun by these apparatus is performed by way of rotations. This is not limitative. For instance, it is possible to adopt a sun-chasing manner wherein the both sides of the solar module is held by a pair of struts connected to an oil cylinder or the like, and the direction of the light receiving face of the solar module is changed to face toward the sun by changing the length of each of the struts by actuating the oil cylinder or the like. In this case, the oil cylinder or the like is corresponding to the drive means in the present invention.

Any of the above manner is to perform direction change of the solar sell toward the sun. To direct the light receiving face of the solar module toward the sun may be performed by other appropriate manners. As a specific example of such manner, there can be mentioned a manner wherein a photoelectric conversion member as the solar module is mounted on a light converging optical system, the optical axis of the light converging optical system is inclined or moved in parallel to the photoelectric conversion member to change the positional relation between the light converging optical system and the photoelectric conversion member, whereby the optical path in the light converging optical system is changed so that the sunlight most effectively arrives at the photoelectric conversion member depending on the position of the sun which is momently changed

### Drive-controlling Means

As the drive-controlling means, it is possible to adopt an appropriate drive-controlling means depending on the kind of the drive means used. The drive-controlling means is required to have a function to generate signal power, pressure or the like and transmit it to the drive means. In order for the drive-controlling means to have such function, the drive-controlling means is preferred to have a mechanism containing a microcomputer therein. And the mechanism is preferred to have an electric circuit capable of inputting and outputting necessary digital signal or analogue signal, or electrical signal for directly driving the drive means.

### Output Detection Means

The output detection means is required to have a function to detect an output (an output value) from the solar module and transmit it to the drive-controlling means.

As a typical example of the output value from the solar module, there can be mentioned an energy value capable of being outputted from the solar module. Specifically, it is the most appropriate to use an output power corresponding to a product of a current and a voltage respectively from the solar module. However, in the simple alternative, it is possible to use a current value or a voltage value from the solar module as the above output value. As the output detection means, it is possible to use a mechanism capable of outputting a voltage value developed across an electrical resistance serialized with an output circuit of the solar module. In order to more precisely detect the output value, it is possible to use a mechanism capable of operating and outputting a product of a voltage value developed across the solar module and said voltage value developed across the electrical resistance. Besides, it is possible to use a mechanism capable of outputting an adequate electric signal in a power conversion means (specifically for instance, an inverter) for converting a d.c. output from the solar module into an a.c. voltage as the output detection means. In this case, it is possible that the output detection means is made such that it is included in the power conversion means or the power conversion means is made such that it serves also as the output detection means. Alternatively, it is possible to use an a.c. power meter for measuring an a.c. power after the power conversion as the output detection means.

In the following, the features and advantaged of the present invention will be described in more detail with reference to example. It should be understood that the example is only for illustrative purposes and are not intended to restrict the scope of the present invention.

### EXAMPLE 1

This example describes an example of a solar power generation system of the optical-concentration type provided according to the present invention.

FIG. 1 is a schematic diagram illustrating the constitution of a principal part of an example of a solar power generation system of the optical-concentration type wherein an optical-concentration type solar module is used, which is provided according to the present invention.

In the solar power generation system shown in FIG 1, a combination of a photoelectric conversion portion and a reflecting mirror serves as a solar module.

In FIG. 1, reference numeral 101 indicates the sun. Reference numeral 102 indicates a photoelectric conversion portion which functions to convert light incident from the sun 101, that is, incident sunlight into an electricity. Reference numeral 103 indicates a reflecting mirror (a light converging optical system) which functions to guide incident light from the sun 101 to the photoelectric conversion portion 102 while increasing the energy density of the light. The reflecting mirror 103 is connected to the photoelectric conversion portion 102 through a retaining means 104 which fixes the reflecting mirror 103 and fixes a relative position between the reflecting mirror 703 and the photoelectric conversion portion 102. Here, a combination 120 of the photoelectric conversion portion 102 and the reflecting mirror 103 functions to convert into a power (a d.c. power) and therefore, the combination 120 can be called a solar module. The reflecting mirror 103 is arranged on a frame 105, which holds the entire system, trough a drive means 106 for driving the reflecting mirror 103. The structure here is made such that the reflecting mirror 103 can be driven by actuating the drive means 106 to optionally change the relative position with the frame 105 so that the solar module 120 can always chase the sun 101 following the movement of the solar module. The sun-chasing is necessary to be performed with reference to the two axes (the declination, the hour angle) which define the position of the sun. However, here, for the simplification purpose, description will be made only with respect to the one axis. Further, as the method of performing the sun-chasing, depending on the kind of the drive means 106, there is a method of performing the sun-chasing by rotating about an independent rotation axis with respect to the azimuth and the hour angle as in the case of a telescope at the astronomical observatory. There is also a method of performing the sun-chasing by rotating complexly with respect to the vertical axis and the zenithal angle. These methods are considered to be dealt with as well as in the above case in view of performing the sun-chasing.

Now, a power generated in the photoelectric conversion portion 102 is sent to a power conversion apparatus 108 through a power output line 107. There is arranged an output detection means 109 between the photoelectric conversion portion 102 and the power conversion apparatus 108 in this case, by outputting a voltage value developed across an electrical resistance serialized with an intermediate portion of the power output line 107, it is possible to monitor an electric current generated by the photoelectric conversion portion 102. Reference numeral III indicates a drive-controlling means which is electrically connected to the output detection means 109. The drive-controlling means 111 also is electrically connected to the drive means 106. An output from the output detection means 109 is introduced into the drive-controlling means 111. The drive-controlling means 111 transmits a drive signal to the drive means 106 while monitoring the output from the output detection means 109. Reference numeral 1211 indicates a clock means which is electrically connected to the drive-controlling means 111. The clock means 121 transmit information relating to prescribed date and time to the drive-controlling means 111. In the drive-controlling means 111, based on the prescribed date-and-time information transmitted from the clock means 121 and the information of the output transmitted from the output detection means 109, a position of the sun at that time is computed in accordance with a previously established equation. The drive-controlling means 111 transmits information of the computed sun's position to the drive means 106 to control the drive means 106 so as to drive such that the solar module 120 faces toward the sun's position.

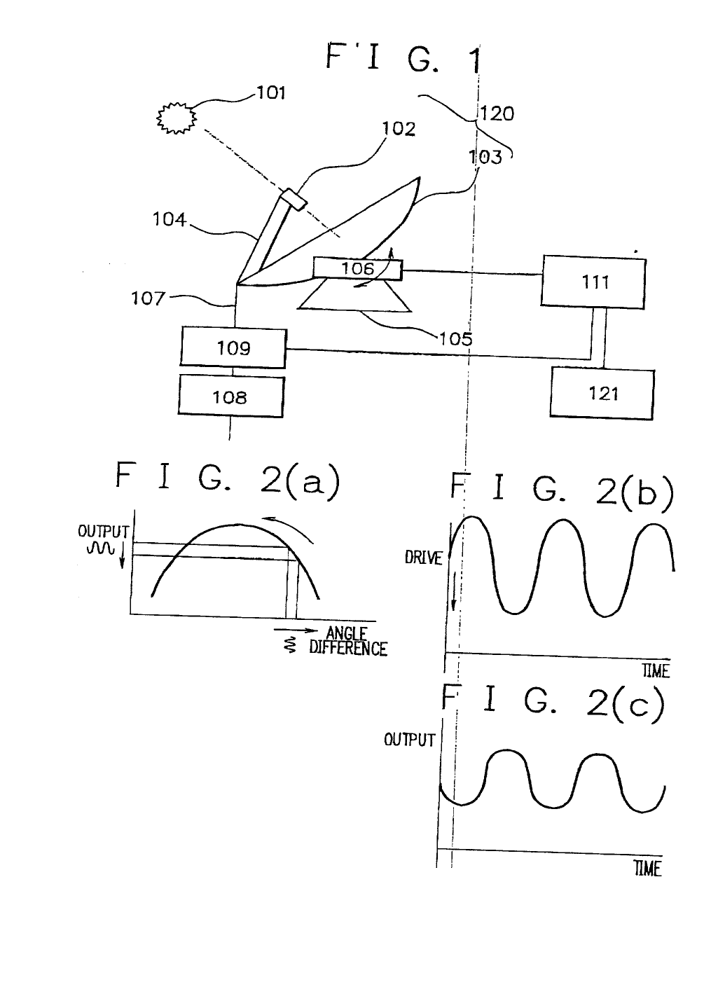

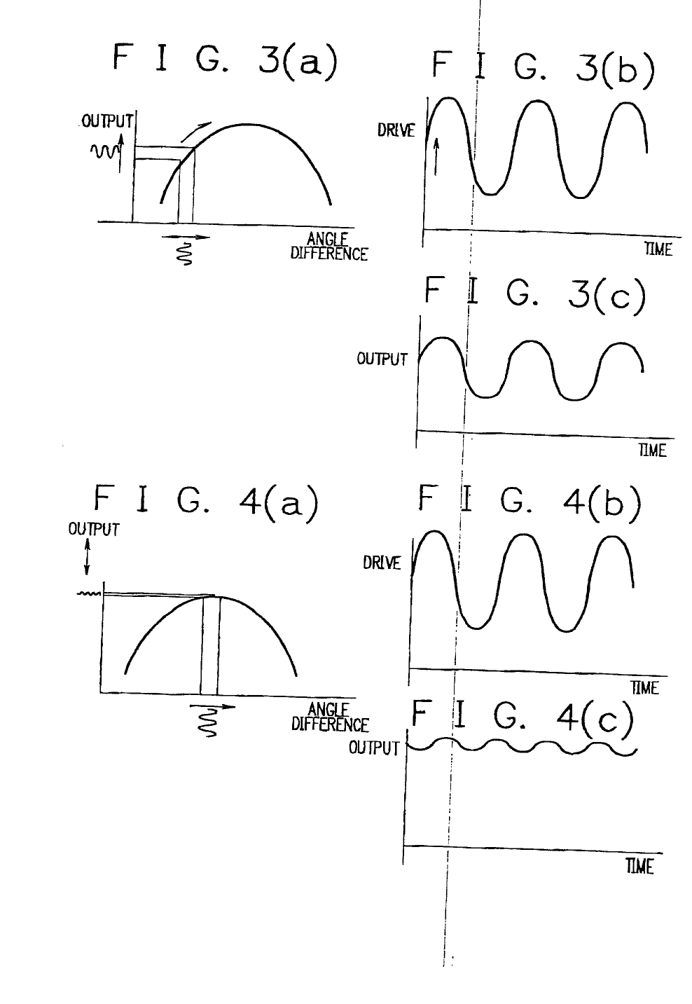

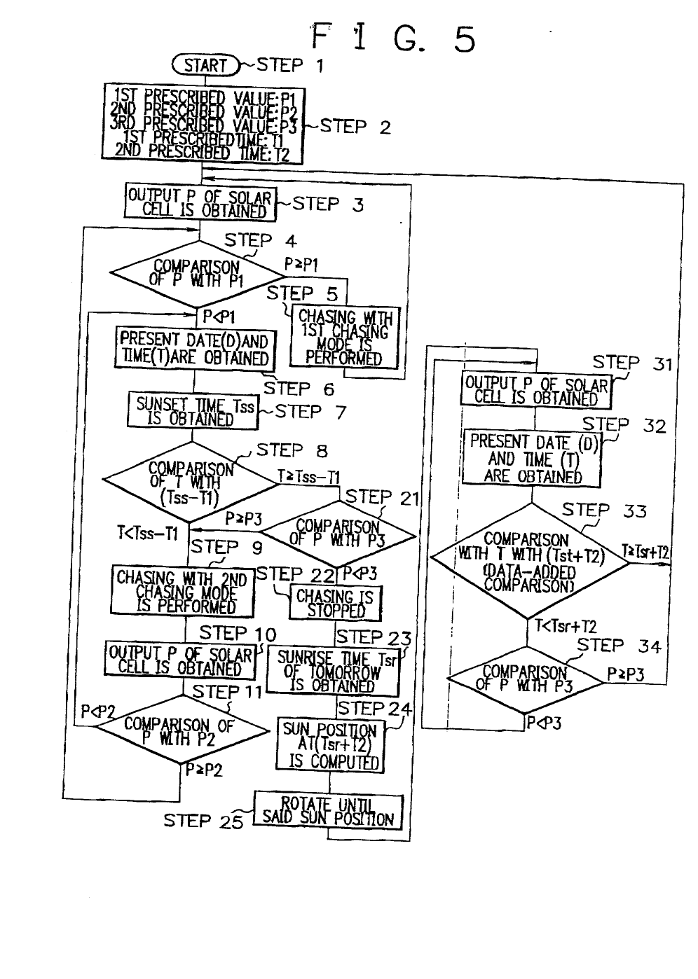

The drive-controlling means 111 generates a slight movement signal to slightly move the drive means 106. For the frequency of the slight movement signal, it may be optionally selected. However, in a viewpoint that the driving system can perform fluctuation in concert with a given slight movement signal, that is, the phase lag becomes substantially zero, the frequency is preferred to be less than ½ of the characteristic frequency of the moving portion including the solar module 120, for the reason that the characteristic frequency already has a phase lag of 45°. Here, presuming that characteristic frequency of the moving portion is 0.5 Hz, a slight movement signal of 0.2 Hz is generated. By this, the direction of the solar module 120 is slightly moved and because of this, an output value from the photoelectric conversion portion 102 is changed. The state thereof is shown in FIG. 2 [FIGS. 2(a) to 2(c)], FIG. 3 [FIGS. 3(a) to 3(c)], and FIG. 4 [FIGS. 4(a) to 4(c)]. FIG. 2 [FIGS. 2(a) to 2(c)] shows an output fluctuation state when the angle θ of the solar module 120 is shifted toward a forward direction from the optimum angle. When the center of the fluctuation is shifted in a forward direction from the peak position of the output from the solar module 120 as shown in FIG. 2(a), the output fluctuation when driven by a substantial sinewave as shown in FIG. 2(b) shows a frequency waveform of anitiphase as shown in FIG. 2(c) When the angle θ of the solar module 120 is shifted toward a reverse direction from the optimum angle as shown in FIG. 3(a), complying with such a slight movement signal as shown in FIG. 3(b), there is shown a frequency waveform of in-phase as shown in FIG. 3(c). On the other hand, when the angle θ of the solar module 120 is the optimum angle as shown in FIG. 4(a), as will be readily expected, the output is not fluctuated at all, or a small signal at a frequency which is 2 times the driving signal is observed.

As will be understood from the above description, it is reasonable to drive toward a reverse direction in the case of FIG. 2 [FIGS. 2(a) to 2(c)] and it is reasonable to drive toward a forward direction in the case of FIG. 3 [FIGS. 3(a) to 3(c)]. In the case of FIG. 4 [FIGS. 4(a) to 4(c)], it is reasonable not to drive.

Based on the above judgment, the drive-controlling means 111 transmits a direct current-like signal in order to drive the drive means 106 toward the judged direction. At that time, the drive-controlling means 111 also transmits the foregoing slight movement signal while being overlapped to the driving signal. By this, the solar module 120 travels toward a given direction while being slightly moving. The movement of the solar module 120 is continued until reaching the optimum angle shown in FIG. 4, and finally reached the optimum angle.

That is, by continuously perform the above operation, it is possible that the solar module 120 continuously chase the sun 101.

FIG. 5 is a schematic flow chart showing motions realized by the above-described sun-chasing mechanism.

In the following, the motion flow will be explained for every step with reference to FIG. 5.

Step 1

The program is actuated.

Step 2

Thresholds P1-P3 and T1-T3 which decide the motions are established. These values may be the corresponding fixed values described in the program or variable values capable of externally established. Alternatively, they may be values which can be changed with elapse of time as such that are changed as an error in the clock means is accumulated.

Step 3

The drive-controlling means 111 obtains output P of the solar module from the output detection means 109.

Step 4

The value of the output P is compared with prescribed value P1.

Step 5

When P≧P1, it is Judged that the output value P is meant that sun-chasing mode based on the output from the solar module is possible. The solar module is driven by this sun-chasing mode. This sun-chasing mode is called first sun-chasing mode. In this case, during the process of performing the drive of the solar module by the first sun-chasing mode, by repeatedly returning to step 3, whether or not the output of the solar module is in a range suitable for the first sun-chasing mode is confirmed in each repetition.

Step 6

In the judgment of Step 3, when it is judged that P<P1, that is, when it is judged that the output P is insufficient in order to use the first sun-chasing mode, in order to switch to second sun-chasing mode, the drive-controlling means 111 instantly acquires information of present date and time from the clock means 121.

Step 7

Based on the date-and-time information acquired in Step 6, sunset time Tss of the date is computed.

Step 8

In order to judge whether the result obtained in Step 4 is due to the weather or a reduction in the solar irradiation before the sunset, present time T and (Tss−T1) are compared. T1 is a first prescribed time.

Step 9

When the compared result Step 8 is T<(Tss−T1), judging that the time is sufficiently close to the sunset time Tss but the solar irradiation will be improved, the solar module is driven by second sun-chasing mode. The second sun-chasing mode is that in accordance with an output from the clock means 121 and based on a previously established equation, the position of the sun at present time is computed, and the drive means 106 is controlled so that the sun is faced to that direction.

Step 10

In order to conduct the judgment in the next step, output P from the solar module is acquired from the output detection means 109.

Step 11

Also in the second sun-chasing mode, the output of the solar module is continuously acquired, judgment is conducted whether the second sun-chasing mode should be continued or the second sun-chasing mode should be switched to the first sun-chasing mode. Here, in the case where it is confirmed that P≧P2, that is, the output P is larger than a second prescribed value P2, it is judged that to switch to the first sun-chasing mode makes it possible to more readily perform the sun-chasing of the solar module, and return to Step 4.

When P<P2, returning to Step 6, the procedures of Step 6 are repeated starting from the acquisition of date-and-time information, where the second sun-chasing mode is continued.

Step 21

in Step 8, in the case where it is judged that T a (Tss−T1), that is, the solar irradiation is reducing because of reaching the sunset, judgment is conducted whether the present output P is larger or small in comparison with a third prescribed value P3 which indicates a continuation limit for the sun-chasing of the solar module in this step. In the case where it is judged that P≧P3, that is, the output P is smaller than P2 but it is larger than P3, to perform the sun-chasing of the solar module in accordance with the second sun-chasing mode is judged to be reasonable, followed by transferring to Step 9. In reverse, when P<P3, to perform the sun-chasing of the solar module is judged to be disadvantageous, successive step which leads to terminate the driving of the solar module is practiced.

Step 22

Steps after this step are of motions of terminating the sun-chasing operation for the solar module. First, the sun-chasing operation itself is terminated.

Step 23

From the date presently retained, there is obtained a sunrise time Tsr in the following day.

Step 24

Using the sunrise time Tsr obtained in the above and a previously established sun position-computing equation, there is operated a direction of the sun at a time which is going ahead of the second prescribed time T2 to the sunrise time Tsr.

Step 25

The solar module is driven toward the direction computed in the above step.

Step 31

Steps after this step are of motions when the sun-chasing of the solar module is commenced in the following day.

First, as information in order to commence the sun-chasing of the solar module, there is obtained an output from the solar module.

Step 32

In order to speculate a case wherein sufficient solar irradiation cannot be obtained because of bad weather, information of present date and time is obtained.

Step 33

Judgment is conducted whether or not the present time reaches a time where there its a fear that the sun will become invisible unless the sun-chasing of the solar module is commenced soon. That is, T and (Tsr+T2) are compared. When T≧(Tsr+T2), that is, the present time is already reached to the aforesaid time, immediately transferring to Step 3, the sun-chasing of the solar module is commenced by adequate sun-chasing mode in concert with the output of the solar module. When T<(Tsr+T2), that is, the present time is yet reached to the aforesaid time, in order to judge whether or not the solar irradiation is large enough for performing the sun-chasing of the solar module, the procedure is transferred to the next step.

Step 34

In this step, judgment is conducted of whether or not the solar irradiation is large enough for performing the sun-chasing of the solar module. When P≧P3, the procedure is transferred to Step 3, where the sun-chasing of the solar module is commenced. When P<P3, the procedure is returned to Step 31, where as information in order to commence the sun-chasing of the solar module, there is obtained an output from the solar module.

In accordance with the above-described motion slow procedures, depending on the output from the solar module and the output from the clock means, the optimum sun-chasing and waiting are possible even when the weather is changed in any way.

As will be understood from the above description, the solar power generation system of the present invention, having such specific sun-chasing mechanism as above described in which on the basis of the output from the solar module installed in the system, the solar module is driven and controlled, have such significant advantages as will be described below.

When the sun shines, the solar module is driven by the first sun-chasing mode. When the output from the solar module becomes to be below the first prescribed value, based on the output from the solar module and the output from the clock means, the first sun-chasing mode is switched to the second sun-chasing mode and the solar module is driven by the second sun-chasing mode, where inaccurate sun-chasing and wrong operation for the solar module under insufficient solar irradiation can be avoided. When the output from the solar module becomes to above the second prescribed value, the second sun-chasing mode is switched to the first sun-chasing mode and the solar module is driven by the first sun-chasing mode, where without having negative influence from an error in the installation of the solar module or an error in the clocking of the clock means, the sun-chasing of the solar module can be performed at a high precision. That is, the sun-chasing driving of the solar module can be always efficiently performed by the optimum method without wastefulness.

Further, the time when the output from the solar module becomes to be below the third prescribed value is within a range of the first prescribed time from the sunset time computed from the clock means, the sun-chasing motion of the solar module is terminated. Separately, it is possible that the solar module is moved to the position of the sun after the second prescribed time since the sunrise time in the morning of the following day and it is stopped and kept in a stand-by condition. By doing in this way, the energy loss occurred when the sun-chasing of the solar module under insufficient solar irradiation before the sunset can be avoided. And during the solar module being kept in a stand-by condition, by recommencing the sun-chasing of the solar module when a time after the second prescribed time since the sunrise time reaches or the output from the solar module becomes to be above the fourth prescribed value, it is possible to seize the sunlight irradiation in the morning of the following day without losing the chance, and even when the solar irradiation is small, it is possible to perform the sun-chasing to a minimum extent for the solar module. That is, the energy for the sun-chasing under condition where the solar radiation is insufficient can be saved.

As above described, in the solar power generation system of the present invention, as a whole, the energy gain for the solar module installed in the system can be maximized.

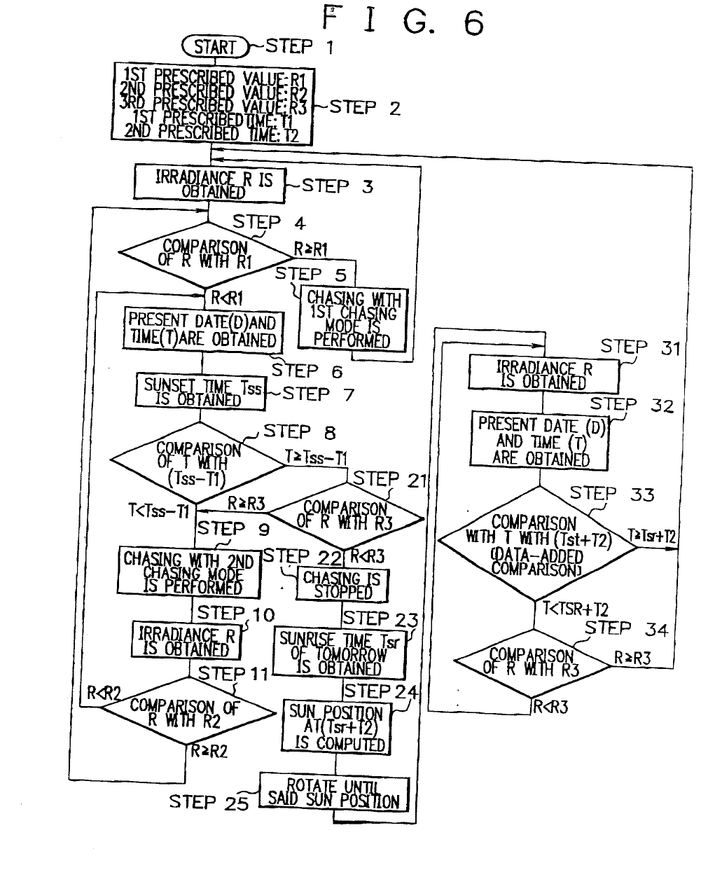

Incidentally, the solar power generation system can be controlled on the basis of the solar irradiation instead the output from the solar module as shown in FIG. 6. In FIG. 6, R indicates a solar irradiation, R1 a first prescribed value, R2 a second prescribed value. R3 a third prescribed value. Other constitutions are the same as those in FIG. 5.

Now, in this example, for the simplification purpose, the sun-chasing and controlling method with respect to uniaxial movement has been described. In the case of biaxial movement, by alternately using different frequencies for the slight movement signal or by alternately performing the slight movement and the detection, the drive and the control can be concurrently performed.

Incidentally, the solar power generation system having such specific sun-chasing mechanism as above described in the present invention has such significant advantages as will be described below.

When the solar irradiation (or the solar irradiance) of the sunlight is large to an extent in that the solar module can sufficiently perform sun-chasing, the solar module is driven by the first sun-chasing mode based on the output from the solar module. When the solar irradiation is reduced to an extent in that the operation of the solar module to receive the sunlight by the first sun-chasing mode is insufficient, the first sun-chasing mode is switched to the second sun-chasing mode based on the output from the clock means and the solar module is driven by the second sun-chasing mode. Thereafter, when the solar irradiation is recovered to a sufficient extent suitable for the solar module to be driven by the first sun-chasing mode, the second sun-chasing mode is switched to the first sun-chasing mode and the solar module is driven by the first sun-chasing mode. By doing in this way, the solar module in the solar power generation system can be always driven by an adequate sun-chasing mode and because of this, the power generation quantity of the solar power generation system can be always maximized.

What is claimed is:

1. A solar power generation system comprising a solar module in which incident light is subjected to photoelectric conversion to afford an output and a sun-chasing mechanism for driving and controlling said solar module based on said output from said solar module, said sun-chasing mechanism having a drive means for changing a direction of said solar module, a drive-controlling means for controlling said drive means, an output detection means for detecting said output from said solar module, and a clock means for transmitting information relating to date and time to said drive-controlling means, wherein said sun-chasing mechanism behaves to perform sun-chasing of said solar module such that the solar module is driven by a first sun-chasing mode when sun shines; when the output value from the solar module becomes to be below a fist prescribed value, the first sun-chasing mode is switched to a second sun-chasing mode based on said output value from the solar module and an output value from said clock means, and the solar module is driven by said second sun-chasing mode; and when the output from the solar module becomes to be above a second prescribed value, the second sun-chasing mode is switched to the fist sun-chasing mode and the solar module is driven by the fist sun-chasing mode; and wherein the sun-chasing mechanism behaves such that when the output value from the solar module becomes to be below a third prescribed value at a time within a range of a first prescribed time from a sunset time computed from the clock means, the sun-chasing of the solar module is terminated.

2. The solar power generation system according to claim 1, wherein the sun-chasing mechanism behaves such that after the solar module is moved to a position of the sun after a second prescribed time since a sunrise time in the morning of the following day, the solar module is stopped.

3. The solar power generation system according to claim 2, wherein the sun-chasing mechanism behaves such that when the output from the clock means reaches a time after said second prescribed time since the sunrise time or the output from the solar module becomes to be above a fourth prescribed value, the sun-chasing of the solar module is commenced.

4. The solar power generation system according to claim 1, wherein the first prescribed time is a time interval obtained by a method in that using sunlight irradiation data in which a case of an average sunlight irradiation condition is presumed, in a time range which is continued in a reverse direction from a sunset time, a value (a) of an energy obtained by the sun-chasing which is accumulated in said reverse direction is computed, a value (b) of an energy consumed for the sun-chasing which is accumulated in said reverse direction is computed, and a time interval (c) required for said value (a) to overtake said value (b) is computed as said time interval.

5. The solar power generation system according to claim 2, wherein the second prescribed time is a time interval obtained by a method in that using sunlight irradiation data in which a case of an average sunlight irradiation condition is presumed, in a time range which is continued from a sun-rise time, a value (a) of an energy obtained by the sun-chasing which is accumulated in a forward direction is computed, a value (b) of an energy consumed for the sun-chasing which is accumulated in a forward direction is computed, and a time interval (c) required for said value (a) to overtake said value (b) is computed as said time interval.

6. A solar power generation system comprising a solar module in which incident light is subjected to photoelectric conversion to afford an output and a sun-chasing mechanism for driving and controlling said solar module based on said output from said solar module, said sun-chasing mechanism having a drive means for changing a direction of said solar module, a drive-controlling means for controlling said drive means, an output detection means for detecting said output from said solar module, and a clock means for transmitting information relating to date and time to said drive-controlling means, wherein said sun-chasing mechanism behaves to perform sun-chasing of said solar module such that the solar module is driven by a first sun-chasing mode when sun shines; when a solar irradiation becomes to be below a fist prescribed value, the first sun-chasing mode is switched to a second sun-chasing mode based on said solar irradiation and an output value from said clock means, and the solar module is driven by said second sun-chasing mode; and when said solar irradiation becomes to be above a second prescribed value, the second sun-chasing mode is switched to the fist sun-chasing mode and the solar module is driven by the fist sun-chasing mode, and wherein the sun-chasing mechanism behaves such that when said solar irradiation becomes to be below a third prescribed value at a time within a range of a first prescribed time from a sunset time computed from the clock means, the sun-chasing of the solar module is terminated.

7. The solar power generation system according to claim 6, wherein the sun-chasing mechanism behaves such that after the solar module is moved to a position of the sun after a second prescribed time since a sunrise time in the morning of the following day, the solar module is stopped.

8. The solar power generation system according to claim 7, wherein the sun-chasing mechanism behaves such that when the output from the clock means reaches a time after said second prescribed time since the sunrise time or the output from the solar module becomes to be above a fourth prescribed value, the sun-chasing of the solar module is commenced.

9. The solar power generation system according to claim 6, wherein the first prescribed time is a time interval obtained by a method in that using sunlight irradiation data in which a case of an average sunlight irradiation condition is presumed, in a time range which is continued in a reverse direction from a sunset time, a value (a) of an energy obtained by the sun-chasing which is accumulated in said reverse direction is computed, a value (b) of an energy consumed for the sun-chasing which is accumulated in said reverse direction is computed, and a time interval (c) required for said value (a) to overtake said value (b) is computed as said time interval.

10. The solar power generation system according to claim 7, wherein the second prescribed time is a time interval obtained by a method in that using sunlight irradiation data in which a case of an average sunlight irradiation condition is presumed in a time range which is continued from a sunrise time, a value (a) of an energy obtained by the sun-chasing which is accumulated in a forward direction is computed, a value (b) of an energy consumed for the sun-chasing which is accumulated in a forward direction is computed, and a time interval (c) required for said value (a) to overtake said value (b) is computed as said time interval.
